(19) United States
(12) Patent Application Publication
(10) Pub. No.: US 2024/0234119 A9
(43) Pub. Date: Jul. 11, 2024

(54) MASS SPECTROMETRY DEVICE AND MASS SPECTROMETRY METHOD

(71) Applicant: HAMAMATSU PHOTONICS K.K., Hamamatsu-shi, Shizuoka (JP)

(72) Inventors: Tsuyoshi HIRAO, Hamamatsu-shi, Shizuoka (JP); Yasuhide NAITO, Hamamatsu-shi, Shizuoka (JP); Norimasa KOSUGI, Hamamatsu-shi, Shizuoka (JP)

(73) Assignee: HAMAMATSU PHOTONICS K.K., Hamamatsu-shi, Shizuoka (JP)

(21) Appl. No.: 18/277,643

(22) PCT Filed: Dec. 6, 2021
(86) PCT No.: PCT/JP2021/044751

§ 371 Date: Aug. 17, 2023

(30) Foreign Application Priority Data
Feb. 22, 2021 (JP) 2021-026072

(51) Int. Cl. H01J 49/04; H01J 49/00

(52) U.S. Cl. CPC H01J 49/0463; H01J 49/0004; H01J 49/0031

(57) ABSTRACT

The mass spectrometer includes a sample stage, an irradiation unit that irradiates the sample with an energy beam and ionizes a component of the sample, an extraction electrode that extracts the ionized sample from the surface of the sample by a potential difference from the sample stage, an MCP that emits electrons in accordance with the ionized sample, an imaging part that acquires an image based on the electrons emitted by the MCP, and a control unit that controls operations of the irradiation unit, the extraction electrode, and the imaging part. The control unit changes the potential of the extraction electrode at a timing in accordance with the detection target component after the irradiation of the energy beam by the irradiation unit, and causes the imaging part to acquire an image as an analysis target in a period in accordance with the detection target component.

### TECHNICAL FIELD

The present disclosure relates to a mass spectrometer and mass spectrometry method.

### BACKGROUND ART

As an apparatus for performing imaging mass spectrometry, a projection type mass spectrometer capable of simultaneously measuring positional information and mass information is known. Patent Document 1 discloses a mechanism in such a projection type mass spectrometer in which the potential of an extraction electrode is made variable in accordance with the component of an ion to be detected in order to improve the mass resolution (time resolution) by making timings at which ions having the same mass reach a detection device as uniform as possible.

### CITATION LIST

### Patent Document

[Patent Document 1] Japanese Patent Application Publication No. 2010-251174

### SUMMARY OF INVENTION

### Technical Problem

In mass spectrometry using such a mass spectrometer as described above, it is required to reduce the amount of data obtained as an analysis target in one measurement as much as possible from the viewpoint of improving the processing speed and saving the data storage area. The mechanism disclosed in Patent Document 1 has room for improvement from the viewpoint described above.

Therefore, an object of an aspect of the present disclosure is to provide a mass spectrometer and a mass spectrometry method capable of improving the processing speed while improving the mass resolution.

### Solution to Problem

A mass spectrometer according to an aspect of the present disclosure includes: a sample stage on which a sample is placed; an irradiation unit configured to irradiate the sample with an energy beam and ionize a component of the sample while maintaining positional information of the sample in a region irradiated with the energy beam; a first electrode configured to extract an ionized sample, which is a component of the sample ionized by the irradiation unit, from a surface of the sample by a potential difference between the first electrode and the sample stage; an electron emission unit disposed downstream of the first electrode in a flight path of the ionized sample and configured to emit electrons in accordance with the ionized sample; an imaging part disposed at a subsequent stage of the electron emission unit and configured to acquire an image based on the electrons emitted by the electron emission unit; and a control unit configured to control operations of the irradiation unit, the first electrode, and the imaging part. The control unit is configured to change a potential of the first electrode at a timing in accordance with a predetermined detection target component among one or more components included in the sample after irradiation of the energy beam by the irradiation unit, and cause the imaging part to acquire the image as an analysis target in a period in accordance with the detection target component. At the timing, the control unit is configured to increase the potential of the first electrode by a predetermined amount when the ionized sample corresponding to the detection target component is a positive ion, and decrease the potential of the extraction electrode by a predetermined amount when the ionized sample corresponding to the detection target component is a negative ion.

According to the above-described mass spectrometer, it is possible to improve the mass resolution of the detection target component by changing the potential of the first electrode at the timing in accordance with the detection target component after the irradiation of the sample with the energy beam. Furthermore, by acquiring an image as an analysis target in a period in accordance with the detection target component, it is possible to reduce the amount of information (data amount) acquired and stored as an analysis target in one imaging. As described above, the processing speed can be improved while improving the mass resolution.

The mass spectrometer may further include a second electrode disposed between the first electrode and the electron emission unit and configured to accelerate the ionized sample extracted by the first electrode by a potential difference from the first electrode. The timing in accordance with the detection target component may be a timing at which the ionized sample corresponding to the detection target component is located between the first electrode and the second electrode. According to the above configuration, the mass resolution of the detection target component can be reliably improved.

The mass spectrometer may further include a phosphor disposed between the electron emission unit and the imaging part and configured to emit light corresponding to the electrons emitted by the electron emission unit. The imaging part may be configured to acquire an image based on the light from the phosphor. According to the above configuration, a sensor or the like that detects light can be used as the imaging part.

A fluorescent material constituting the phosphor may be GaN, ZnO or a plastic scintillator. According to the above configuration, the afterglow time of the fluorescent material can be shortened. Therefore, even when the interval between a timing at which one component reaches the imaging part and a timing at which the other component reaches the imaging part is short, the phosphor can emit light corresponding to the other component without being affected by afterglow corresponding to the one component. Accordingly, light corresponding to each component can be emitted with high accuracy, and the accuracy of mass spectrometry can be improved.

The imaging part may include a gate mechanism configured to be switchable between an open state in which an image based on the light from the phosphor is captured and a close state in which an image based on the light from the phosphor is not captured. The control unit may be configured to control the operation of the gate mechanism so that the open state is set in the period in accordance with the detection target component and the close state is set in a period other than the period. According to the above configuration, by performing the imaging process only in the period in accordance with the detection target component by the opening/closing operation of the gate mechanism, it is possible to appropriately suppress the amount of information acquired and stored in one imaging.

The imaging part may include: an image intensifier having the gate mechanism; and a solid state image sensor disposed at the subsequent stage of the image intensifier. According to the above configuration, it is possible to amplify light from the phosphor by the image intensifier and cause the solid state image sensor to capture an image. Therefore, even when the light from the phosphor is very weak, the light can be imaged. In general, the switching speed of the gate mechanism of the image intensifier is higher than that of the mechanical gate mechanism. Therefore, by using the gate mechanism of the image intensifier, even when the interval between a timing at which one component reaches the imaging part and a timing at which the other component reaches the imaging part is short, the images corresponding to the respective components can be appropriately separated and captured.

The energy beam may be a laser beam, an electron beam, or an ion beam. According to the above configuration, it is possible to select an appropriate type of energy beam as necessary.

When a unit process corresponding to one irradiation of the energy beam by the irradiation unit is one event, the control unit may be configured to execute a plurality of events while changing the detection target component for every event. According to the above configuration, it is possible to acquire images (perform imaging mass spectrometry) corresponding to each of a plurality of components while suppressing the amount of information in one event.

A mass spectrometry method according to another aspect of the present disclosure includes a first step of ionizing a component of a sample while maintaining positional information of the sample in a region irradiated with an energy beam by irradiating the sample with the energy beam by an irradiation unit configured to irradiate the sample with the energy beam; a second step of extracting an ionized sample, which is a component of the sample ionized by the irradiation unit, from a surface of the sample by a potential difference between a sample stage on which the sample is placed and a first electrode; a third step of changing a potential of the first electrode at a timing in accordance with a predetermined detection target component among one or more components included in the sample after irradiation of the energy beam by the irradiation unit; a fourth step of causing an electron emission unit disposed downstream of the first electrode in a flight path of the ionized sample to emit electrons in accordance with the ionized sample; and a fifth step of causing an imaging part disposed at a subsequent stage of the electron emission unit to acquire an image based on the electrons emitted by the electron emission unit. In the third step, when the ionized sample corresponding to the detection target component is a positive ion, the potential of the first electrode is increased by a predetermined amount, and when the ionized sample corresponding to the detection target component is a negative ion, the potential of the extraction electrode is decreased by a predetermined amount. In the fifth step, the imaging part is caused to acquire the image as an analysis target in a period in accordance with the detection target component.

According to the mass spectrometry method described above, it is possible to improve the mass resolution of the detection target component by changing the potential of the first electrode at a timing in accordance with the detection target component after irradiation of the sample with the energy beam. Furthermore, by acquiring an image as an analysis target in a period in accordance with the detection target component, it is possible to reduce the amount of information (data amount) acquired and stored as an analysis target in one imaging. As described above, the processing speed can be improved while improving the mass resolution.

When a unit process from the first step to the fifth step is one event, a plurality of the events may be executed while changing the detection target component for every event. According to the above configuration, it is possible to acquire images (perform imaging mass spectrometry) corresponding to each of a plurality of components while suppressing the amount of information in one event.

### Advantageous Effects of Invention

According to an aspect of the present disclosure, it is possible to provide a mass spectrometer and a mass spectrometry method capable of improving a processing speed while improving a mass resolution.

### BRIEF DESCRIPTION OF DRAWINGS

FIG. 1 is a diagram showing a configuration of a mass spectrometer according to an embodiment.

FIG. 2 is an explanatory diagram of differential acceleration after extraction.

FIG. 3 is a diagram showing opening/closing control of the gate mechanism.

FIG. 4 is a diagram illustrating an example of a combination of controlling the extraction electrode and controlling the gate mechanism.

FIG. 5 is a diagram illustrating patterns of opening/closing control of the gate mechanism and potential control of the extraction electrode according to an embodiment.

FIG. 6 is a diagram illustrating an operation of a plurality of events according to an embodiment.

FIG. 7 is a diagram showing a first modification of the imaging unit.

FIG. 8 is a diagram showing opening/closing control of the gate mechanism in the first modification of the imaging unit.

FIG. 9 is a diagram showing a second modification of the imaging unit.

### DESCRIPTION OF EMBODIMENTS

Hereinafter, embodiments of the present invention will be described in detail with reference to the drawings. In the drawings, the same or corresponding portions are denoted by the same reference numerals, and redundant description is omitted.

[Mass Spectrometer]

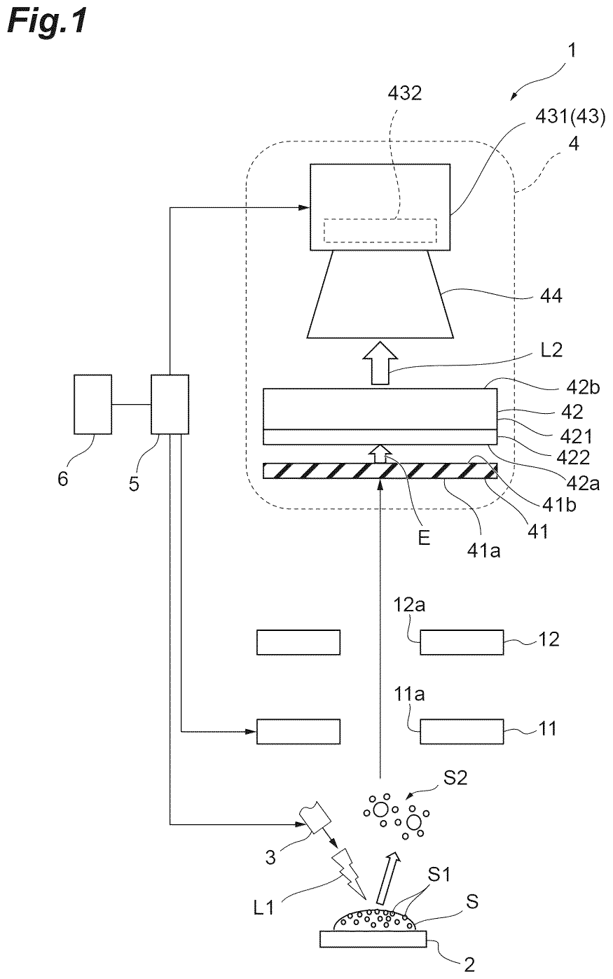

As shown in FIG. 1, the mass spectrometer 1 includes a sample stage 2, an irradiation unit 3, an imaging unit 4, a control unit 5, a data processing unit 6, an extraction electrode 11 (first electrode), and a ground (GND) electrode 12 (second electrode). The mass spectrometer 1 is used for mass spectrometry method such as a laser desorption/ionization (LDI) method, a surface-assisted laser desorption/ionization (SALDI) method, a matrix-assisted laser desorption/ionization (MALDI) method, and a secondary ion mass spectrometry (SIMS) method. The mass spectrometer 1 may be used in a mass spectrometry method using DIUTHAME, which is an ionization-assisting substrate manufactured by Hamamatsu Photonics K.K.

A sample S is placed on the sample stage 2. In a case where the support substrate (for example, the ionization-assisted substrate described above) supporting the sample S is used, the support substrate is placed on the sample stage 2 together with the sample S. The sample stage 2 is, for example, a glass substrate on which a transparent conductive film such as an indium tin oxide (ITO) film is formed, and the surface of the transparent conductive film serves as a mounting surface. A voltage is applied to the sample stage 2. The sample stage 2 may be a member capable of securing conductivity (for example, a substrate made of a metallic material such as stainless steel). The sample S is, for example, a biological sample. The irradiation unit 3 is disposed on the side of a surface of the sample stage 2 on which the sample S is placed.

The irradiation unit 3 collectively irradiates a predetermined range having a predetermined area of the sample S with an energy beam L1. In the present embodiment, the irradiation unit 3 irradiates the sample S with the energy beam L1 which is a flat beam having a spot size including the predetermined range. The spot size of the energy beam L1 may be a size including the entire sample S to be measured or a size including only a part of the sample S. In the latter case, an image of the entire sample S can be obtained by irradiating the sample S with the energy beam L1 a plurality of times while moving an irradiation region of the energy beam L1 (a region on the sample S irradiated with the energy beam L1). When the energy beam L1 is irradiated, a plurality of components S1 of the sample S within the predetermined range are ionized at once.

The irradiation unit 3 ionizes a plurality of components S1 while maintaining positional information of the sample S in the region irradiated with the energy beam L1. That is, the component S1 of the sample S is ionized by the irradiation of the energy beam L1. As a result, an ionized sample S2 which is a component S1 of the ionized sample S is generated. The sample stage 2 may be fixed by sandwiching both end portions (both sides) of the sample stage 2 with metals or the like. In this case, the irradiation unit 3 may be disposed on the opposite side (back surface side) of the surface of the sample stage 2 on which the sample S is placed. That is, the irradiation unit 3 may irradiate the sample S with the energy beam L1 from the back surface side of the sample stage 2.

In the present embodiment, the mass spectrometer 1 is configured as a projection type mass spectrometer. For example, in a scanning type mass spectrometer, a signal of one pixel having a size corresponding to a spot diameter of an energy beam is acquired for each irradiation of the energy beam. That is, in the scanning type mass spectrometer, the resolution of the obtained image depends on the spot size of the energy beam L1. On the other hand, in the projection type mass spectrometer 1, a signal of an image (a plurality of pixels) corresponding to the spot size of the energy beam L1 is acquired for each irradiation of the energy beam L1. That is, in the projection type mass spectrometer, the resolution of the obtained image does not depend on the spot size of the energy beam L1. Therefore, according to the mass spectrometer 1, an image having a resolution (spatial resolution) higher than that of the scanning type mass spectrometer can be obtained.

The energy beam L1 is, for example, a laser beam. The energy beam L1 is, for example, N2 laser or YAG laser. The intensity distribution of the energy beam L1 (intensity distribution in a cross section perpendicular to the axial line) is substantially uniform. The spot size of the energy beam L1 is, for example, about 100 μm to 300 μm. The energy beam L1 may be an electron beam or an ion beam. The irradiation unit 3 irradiates the energy beam L1 in a pulsed manner. The irradiation unit 3 irradiates the energy beam L1 for each event. The irradiation unit 3 irradiates the energy beam L1 once in one event. That is, one irradiation of the energy beam L1 corresponds to one event.

The extraction electrode 11 is disposed at a position facing the surface of the sample stage 2 on which the sample S is placed. That is, the extraction electrode 11 is disposed on the flight path of the ionized sample S2 from the sample stage 2 to the imaging unit 4. The extraction electrode 11 is, for example, a plate-shaped electrode, and has a through hole 11a through which the ionized sample S2 passes. Here, the sample stage 2 described above functions as a plate-shaped electrode facing the extraction electrode 11.

When the ionized sample S2 is a positive ion, the potential of the extraction electrode 11 is set to be lower than that of the sample stage 2 at the time when the irradiation unit 3 irradiates the energy beam L1. Thus, the ionized sample S2 is extracted from the surface of the sample S to the extraction electrode 11 side. As described above, the extraction electrode 11 extracts the ionized sample S2 from the surface of the sample S by the potential difference between the extraction electrode 11 and the sample stage 2. When the ionized sample S2 is a negative ion, the potential of the extraction electrode 11 is set to be higher than that of the sample stage 2 at the time when the irradiation unit 3 irradiates the energy beam L1. Thus, the ionized sample S2 is extracted from the surface of the sample S to the extraction electrode 11 side. In the following description, it is assumed that the ionized sample S2 is a positive ion. When the ionized sample S2 is a negative ion, the magnitude of the potential between the electrodes and the direction in which the potential of the extraction electrode is changed are opposite to those described below.

The ground electrode 12 is disposed downstream of the extraction electrode 11 in the flight path of the ionized sample S2. Specifically, the ground electrode 12 is disposed between the extraction electrode 11 and a micro-channel plate (hereinafter referred to as an “MCP”) 41 (electron emission unit) included in the imaging unit 4. The ground electrode 12 is, for example, a plate-shaped electrode and has a through hole 12a through which the ionized sample S2 passes. The ground electrode 12 accelerates the ionized sample S2 extracted by the extraction electrode 11 due to a potential difference between the ground electrode 12 and the extraction electrode 11. More specifically, the potential of the ground electrode 12 is set lower than the potential of the extraction electrode 11, so that the ionized sample S2 is accelerated from the extraction electrode 11 side to the ground electrode 12 side. The potential of the ground electrode 12 is set to, for example, 0V.

The imaging unit 4 includes the MCP 41, a phosphor 42, an imaging part 43, and an optical lens (connection unit) 44. The MCP 41 is disposed downstream of the extraction electrode 11 and the ground electrode 12 in the flight path of the ionized sample S2. In FIG. 1, the flight path of the ionized sample S2 is substantially linear from the sample stage 2 toward the MCP 41, and the MCP 41 is disposed at a position facing the sample stage 2. However, the flight path of the ionized sample S2 is not limited to such a substantially linear path. That is, the MCP 41 is not necessarily disposed at a position facing the sample stage 2. For example, when triple focusing time-of-flight (TRIFT) in which the orbit of the ionized sample S2 is bent three times and flown, a reflectron in which the ionized sample S2 is flown in a V-shape, MULTUM in which the ionized sample S2 is flown in an 8-shape, or the like is used as a method of guiding the ionized sample S2 from the sample stage 2 to the MCP 41, the MCP 41 does not face the sample stage 2. The path length from the sample stage 2 to the imaging part 43 (a surface detecting an electron or light) is, for example, about 80 cm.

The ionized sample S2 accelerated by the sample stage 2, the extraction electrode 11, and the ground electrode 12 flies toward the MCP 41 and collides with the MCP 41. A plurality of ionized samples S2 flies while maintaining positional information, and collides with the MCP 41 in a state having time difference information caused by a difference in masses. That is, the ionized samples S2 reach the MCP 41 at different timings according to the difference in masses for each type of ionized sample.

The MCP 41 emits electrons E (photoelectrons) in accordance with the ionized sample S2. More specifically, the MCP 41 has an input surface 41a facing the sample stage 2 and an output surface 41b opposite to the input surface 41a. The MCP 41 outputs electrons E from the output surface 41b in response to incidence of ions (charged particles) on the input surface 41a. That is, the MCP 41 converts the spatial distribution of ions into a spatial distribution of electrons (electron image).

The MCP 41 has, for example, a plate-like structure in which a plurality of glass capillaries (channels) having an inner diameter of several μm to several tens of μm are bundled. Each channel of the MCP 41 functions as an independent secondary electron multiplier. That is, in the MCP 41, the ions reaching the surface of the channel are converted into secondary electrons, and the secondary electrons are multiplied while repeating collisions in the channel. The time from ion collision to extraction of secondary electrons is several nanoseconds or less. The imaging unit 4 may include a plurality of stages of MCPs 41.

The phosphor 42 is disposed downstream of the MCP 41. That is, the phosphor 42 is disposed between the MCP 41 and the imaging part 43 on the side opposite to the sample stage 2 with respect to the MCP 41. The phosphor 42 has an input surface 42a facing the MCP 41 and an output surface 42b opposite to the input surface 42a. The input surface 42a functions as an electron detection surface.

The phosphor 42 includes a substrate 421 and a fluorescent layer 422. The phosphor 42 is disposed so that the fluorescent layer 422 faces the MCP 41. The input surface 42a described above is a surface of the fluorescent layer 422 on the MCP 41 side, and the output surface 42b is a surface of the substrate 421 on the side opposite to the MCP 41 side. The material of the substrate 421 is, for example, transparent glass. The material of the substrate 421 is sapphire, for example. The fluorescent layer 422 is applied to a surface of the substrate 421 opposite to the output surface 42b. The fluorescent layer 422 is formed of a fluorescence material that emits fluorescence when electrons collide with the fluorescent layer 422. The fluorescent material of the fluorescent layer 422 is, for example, GaN. The fluorescence material of the fluorescent layer 422 may be, for example, ZnO or a plastic scintillator.

The fluorescent layer 422 emits fluorescence L2 corresponding to the electrons E emitted from the MCP 41. The fluorescent layer 422 converts a fluorescence L2 caused by collision of electrons E into a fluorescence pattern (optical image). The fluorescence material emits light even after the electron excitation disappears, and has afterglow characteristics that gradually become weaker. The afterglow time of the fluorescent layer 422 is, for example, equal to or less than 12 ns. The afterglow time of the fluorescent layer 422 is, for example, about 3 ns. That is, the phosphor 42 is a so-called high-speed phosphor. In the mass spectrometer 1, the MCP 41 and the fluorescent layer 422 are close to each other within a range in which discharge does not occur, and a high voltage is applied to each of them. In the mass spectrometer 1, ions and electrons are caused to collide with the MCP 41 and the fluorescent layer 422 at high speed, thereby achieving both a signal amplification factor (gain) and positional information.

When the fluorescence material of the fluorescent layer 422 is GaN or ZnO, the fluorescent layer 422 can be formed by, for example, epitaxially growing the fluorescence material on the substrate 421 (e.g., sapphire substrate). In this case, the thickness of the fluorescent layer 422 is, for example, about 1 μm to 5 μm. Alternatively, the fluorescent layer 422 may be formed by applying a powdered fluorescent material made of, for example, ZnO onto the substrate 421 (e.g., sapphire substrate). In this case, the thickness of the fluorescent layer 422 is, for example, about 2 μm to 8 μm.

The imaging part 43 is disposed downstream of the phosphor 42. That is, the imaging part 43 is disposed on the side opposite to the MCP 41 with respect to the phosphor 42. The imaging part 43 includes a solid state image sensor 431. The solid state image sensor 431 acquires (captures) an image based on the electrons E emitted from the MCP 41. In the present embodiment, since the electrons E are converted into fluorescence L2 by the phosphor 42, the solid state image sensor 431 acquires (captures) an image based on the fluorescence L2 from the phosphor 42. The solid state image sensor 431 is, for example, a CMOS image sensor. The solid state image sensor 431 may be, for example, a CCD image sensor or a high-speed image sensor.

The solid state image sensor 431 includes a gate mechanism 432. The gate mechanism 432 is configured to be switchable between an open state in which an image based on the fluorescence L2 from the phosphor 42 is captured and a close state in which an image based on the fluorescence L2 from the phosphor 42 is not captured. The minimum period of the open state of the gate mechanism 432 (i.e., a minimum interval from a time point in which the close state is changed to the open state to a time point in which the open state is changed to the close state again) is substantially equal to the afterglow time of the fluorescent layer 422. The minimum period of the open state of the gate mechanism 432 is, for example, about 3 ns. The timing of opening and closing of the gate mechanism 432 is variable.

The optical lens 44 is disposed between the phosphor 42 and the imaging part 43. The optical lens 44 optically connects the phosphor 42 and the imaging part 43. The optical lens 44 is connected to the imaging part 43. The optical lens 44 guides the fluorescence L2 from the phosphor 42 to the imaging part 43.

The control unit 5 controls operations of the irradiation unit 3, the extraction electrode 11, and the imaging part 43. The control unit 5 controls the irradiation unit 3 to irradiate the energy beam L1 in a pulsed manner. Further, the control unit 5 controls the potential of the extraction electrode 11. That is, the control unit 5 controls the magnitude of the voltage applied to the extraction electrode 11. The control unit 5 controls the opening/closing operation of the gate mechanism 432. The control unit 5 controls the imaging part 43 to execute imaging processing. The control unit 5 is, for example, a computer device including a processor (for example, a CPU or the like), a memory (for example, a ROM, a RANI or the like), or the like.

The data processing unit 6 processes the data of the image captured by the imaging part 43. The data processing unit 6 is, for example, a computer device including a processor (for example, a CPU or the like), a memory (for example, a ROM, a RANI or the like), or the like. In the example of FIG. 1, the control unit 5 and the data processing unit 6 are separately described, but the control unit 5 and the data processing unit 6 may be configured by the same computer device.

Details of the control by the control unit 5 will be described. There is a variation in the initial speed and the pop-out direction of the ionized sample S2 generated by irradiation of the energy beam L1. For this reason, there is a variation in the arrival time at which the ionized sample S2 arrives at the imaging part 43 among a plurality of ionized sample S2 having the same masses. In other words, there is a certain variation (time span) in the flight time until a group of the ionized samples S2 having the same masses reaches the imaging part 43. In order to increase the accuracy of mass spectrometry, it is required to improve the mass resolution (time resolution) by reducing such a time span as much as possible. That is, the timings at which the group of ionized samples S2 having the same masses arrives at the imaging part 43 are required to be as close as possible. Therefore, the control unit 5 executes post extraction differential acceleration (PEDA) in order to improve the mass resolution of a predetermined detection target component among one or more components S1 included in the sample S.

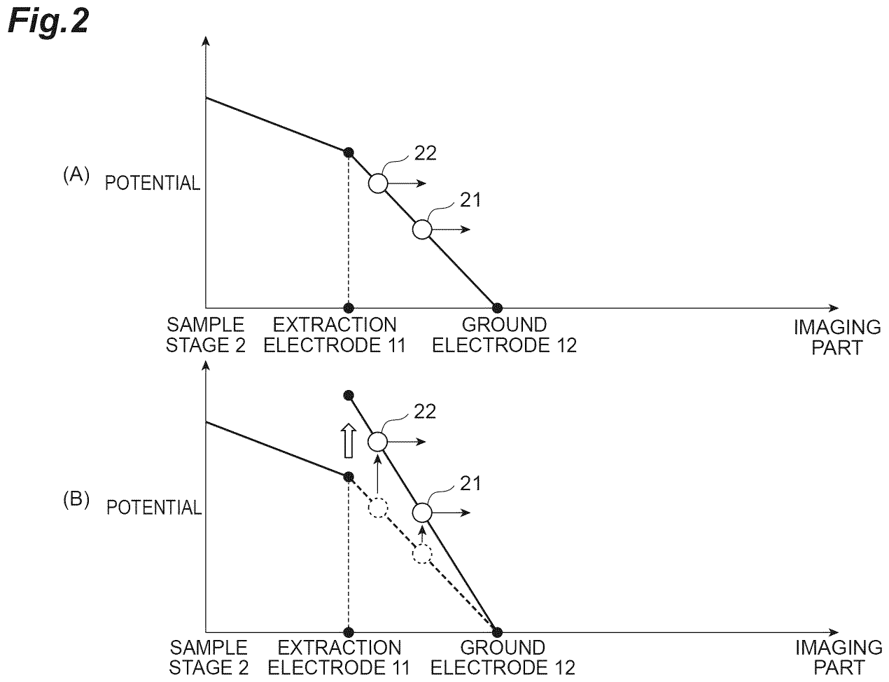

More specifically, after the irradiation unit 3 irradiates the energy beam L1, the control unit 5 changes the potential of the extraction electrode 11 at a timing in accordance with the detection target component (that is, the ionized sample S2 having a specific mass). FIG. 2 is a diagram schematically showing the control (PEDA). In the graph shown in FIG. 2, the horizontal axis represents the position of the ionized sample S2, and the vertical axis represents the potential applied to each electrode (the sample stage 2, the extraction electrode 11, and the ground electrode 12). The two ionized samples 21 and 22 schematically illustrated in FIG. 2 are ions having the same masses (ions corresponding to the same component S1).

The control unit 5 increases the potential of the extraction electrode 11 by a predetermined amount at a timing when the ionized samples 21 and 22 corresponding to the detection target component are located between the extraction electrode 11 and the ground electrode 12. That is, the control unit 5 changes the potential of the extraction electrode 11 from the state shown in (A) of FIG. 2 to the state shown in (B) of FIG. 2. Accordingly, a larger acceleration energy is applied to the ionized sample 22 having a small initial velocity (that is, ions flying at a position farther from the ground electrode 12) than to the ionized sample 21 having a large initial velocity (that is, ions flying at a position closer to the ground electrode 12). The amount of change in the height position of each of the ionized samples 21 and 22 shown in (B) of FIG. 2 corresponds to the acceleration energy applied to each of the ionized samples 21 and 22. As a result, it is possible to absorb a difference in flight time caused by a difference in initial velocity between the ionized samples 21 and 22. That is, it is possible to make the timing at which the ionized sample 21 reaches the imaging part 43 close to the timing at which the ionized sample 22 reaches the imaging part 43, and to improve the mass resolution of the component S1 corresponding to the ionized samples 21 and 22.

Here, the timing at which the ionized sample S2 corresponding to the detection target component is located between the extraction electrode 11 and the ground electrode 12 may be determined in advance through experiments, simulations, or the like. Alternatively, the timing may be determined by performing a predetermined calculation based on various parameters such as the mass-to-charge ratio (m/z) of the ion of the detection target component, the acceleration voltage of the ion (i.e., the potentials set to the sample stage 2, the extraction electrode 11, and the ground electrode 12), and the distances from the sample stage 2 to the extraction electrode 11 and to the ground electrode 12. The timing is, for example, several microseconds after the irradiation time point of the energy beam L1.

Further, the control unit 5 causes the imaging part 43 to acquire an image as an analysis target in a period in accordance with the detection target component. Here, the period in accordance with the detection target component is a partial period including the timing at which the fluorescence L2 corresponding to the detection target component reaches the imaging part 43. For example, the control unit 5 controls the operation of the gate mechanism 432 such that the open state is set in a specific period in accordance with the detection target component and the close state is set in a period other than the specific period.

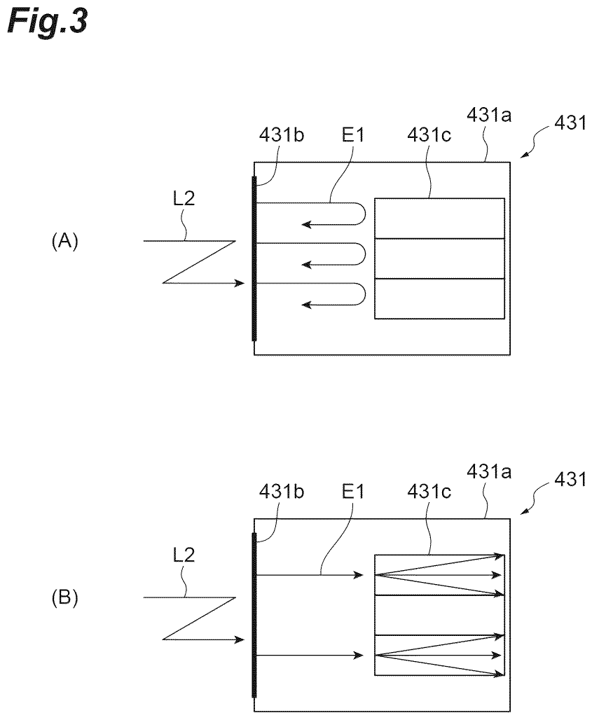

The opening/closing control of the gate mechanism 432 will be described with reference to FIG. 3. Here, a case where the solid state image sensor 431 includes a housing 431a, a photocathode 431b, and a CMOS image sensor 431c will be described as an example. The photocathode 431b is provided on an incident surface of the fluorescence L2 in the housing 431a (that is, a surface facing the optical lens 44). The CMOS image sensor 431c is provided at a position facing the photocathode 431b in the evacuated housing 431a. The photocathode 431b emits electrons E1 (photoelectrons) corresponding to the fluorescence L2 incident on the photocathode 431b to the CMOS image sensor 431c in the housing 431a. The CMOS image sensor 431c detects the electrons E1. In the configuration example of FIG. 3, the gate mechanism 432 is implemented by the photocathode 431b and the CMOS image sensor 431c. More specifically, the switching control of the gate mechanism 432 is realized by controlling the magnitude relationship between the potential of the photocathode 431b and the potential of the CMOS image sensor 431c.
(A) of FIG. 3 shows the close state. The control unit 5 controls the electron E1 emitted from the photocathode 431b not to be directed toward the CMOS image sensor 431c by making the potential of the photocathode 431b larger than the potential of the CMOS image sensor 431c. Thus, the close state is realized.
(B) of FIG. 3 shows the open state. The control unit 5 controls the electron E1 emitted from the photocathode 431b to be directed toward the CMOS image sensor 431c by making the potential of the photocathode 431b smaller than the potential of the CMOS image sensor 431c. Thus, the open state is realized.

Here, the period in accordance with the detection target component (in the present embodiment, a period in which the gate mechanism 432 is set to the open state) may be determined in advance by an experiment, a simulation, or the like, similarly to the timing in which the potential of the extraction electrode 11 is changed described above. Alternatively, the period may be determined by performing a predetermined calculation based on various parameters such as the mass-to-charge ratio (m/z) of the ion of the detection target component, the acceleration voltage of the ion (i.e., the potentials set to the sample stage 2, the extraction electrode 11, and the ground electrode 12), and the distances from the sample stage 2 to the extraction electrode 11 and to the ground electrode 12.

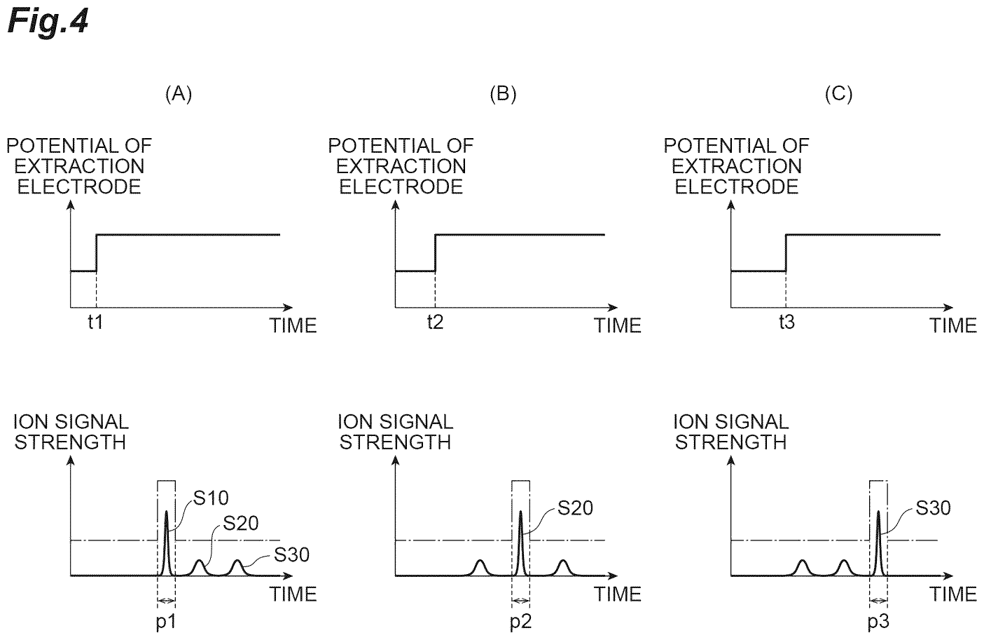

Next, an example of a combination of control for the extraction electrode 11 and the gate mechanism 432 will be described with reference to FIG. 4. In each of (A) to (C) of FIG. 4, the upper graph shows the potential of the extraction electrode 11. In the upper graph, the horizontal axis represents time with reference (origin) to the point in time when the energy beam L1 is irradiated onto the sample S by the irradiation unit 3, and the vertical axis represents the potential of the extraction electrode 11. The lower graph shows the ion signal strength detected when the fluorescence L2 corresponding to the three components S10, S20, and S30 (that is, components having different masses) included in the sample S reaches the imaging part 43. In the lower graph, the horizontal axis represents time with reference (origin) to the point in time when the energy beam L1 is irradiated onto the sample S by the irradiation unit 3, and the vertical axis represents the ion signal strength.
(A) of FIG. 4 illustrates a control example in a case where the component S10 having the shortest flight time (that is, the earliest arrival time at the imaging part 43) among the three components S10, S20, and S30 included in the sample S is set as the detection target component. In this example, as shown in the upper graph, the control unit 5 increases the potential of the extraction electrode 11 by a predetermined amount at the timing t1 in accordance with the component S10. The timing t1 is an arbitrary timing at which the ionized sample S2 corresponding to the component S10 is located between the extraction electrode 11 and the ground electrode 12. As a result, as shown in the lower graph, the time range in which the ionized sample S2 corresponding to the component S10 reaches the imaging part 43 can be reduced compared to the case where the potential of the extraction electrode 11 is not controlled (for example, the case of (B) or (C) of FIG. 4). That is, the mass-resolution for the component S10 can be improved.

Further, the control unit 5 controls the operation of the gate mechanism 432 so that the open state is set in the period p1 in accordance with the component S10 and the close state is set in the period other than the period p1. The dashed-dotted line in the lower graph represents a close state (a state in which the dashed-dotted line is at a low position) and an open state (a state in which the dashed-dotted line is at a high position) of the gate mechanism 432. In this manner, the entire period after the irradiation of the energy beam L1 by the irradiation unit 3 is not set as the analysis target, but only the period p1 in accordance with the component S10 is set as the analysis target, and thus it is possible to reduce the amount of information (data amount) acquired and stored in one imaging. The period p1 is, for example, a period in which only the fluorescence L2 corresponding to the component S10 can be imaged. Note that “imaging only the fluorescence L2 corresponding to the component S10” includes not only a case where fluorescence other than the fluorescence L2 corresponding to the component S10 is not imaged at all but also a case where fluorescence (noise) corresponding to another component that can be ignored in measurement is imaged together with the component S10.
(B) of FIG. 4 illustrates a control example in a case where the component S20 whose flight time is the second shortest after the component S10 is set as the detection target component. In this example, as shown in the upper graph, the control unit 5 increases the potential of the extraction electrode 11 by a predetermined amount at the timing t2 in accordance with the component S20. The timing t2 is a timing later than the timing t1, and is an arbitrary timing at which the ionized sample S2 corresponding to the component S20 is located between the extraction electrode 11 and the ground electrode 12. As a result, as shown in the lower graph, the time range in which the ionized sample S2 corresponding to the component S20 reaches the imaging part 43 can be reduced compared to the case where the potential of the extraction electrode 11 is not controlled (for example, the case of (A) of (C) of FIG. 4). Further, the control unit 5 controls the operation of the gate mechanism 432 so that the open state is set in the period p2 in accordance with the component S20 and the close state is set in the period other than the period p2. According to the above-described control, the same effect as the effect for the component S10 described with reference to (A) of FIG. 4 can be obtained for the component S20.
(C) of FIG. 4 illustrates a control example in a case where the component S30 having the longest flight time is set as the detection target component. In this example, as shown in the upper graph, the control unit 5 increases the potential of the extraction electrode 11 by a predetermined amount at the timing t3 in accordance with the component S30. The timing t3 is a timing later than the timing t2, and is an arbitrary timing at which the ionized sample S2 corresponding to the component S30 is located between the extraction electrode 11 and the ground electrode 12. As a result, as shown in the lower graph, the time range in which the ionized sample S2 corresponding to the component S30 reaches the imaging part 43 can be reduced compared to the case where the potential of the extraction electrode 11 is not controlled (for example, the case of (A) or (B) of FIG. 4). Further, the control unit 5 controls the operation of the gate mechanism 432 so that the open state is set in the period p3 in accordance with the component S30 and the close state is set in the period other than the period p3. According to the above-described control, the same effect as the effect for the component S10 described with reference to (A) of FIG. 4 can be obtained for the component S30.

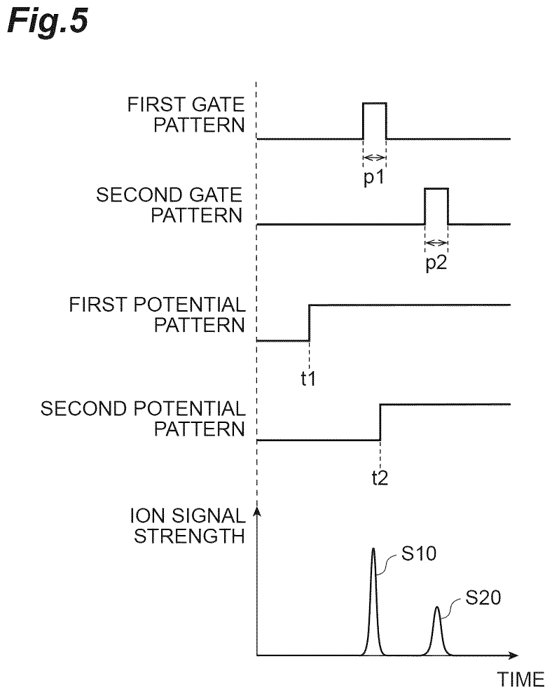

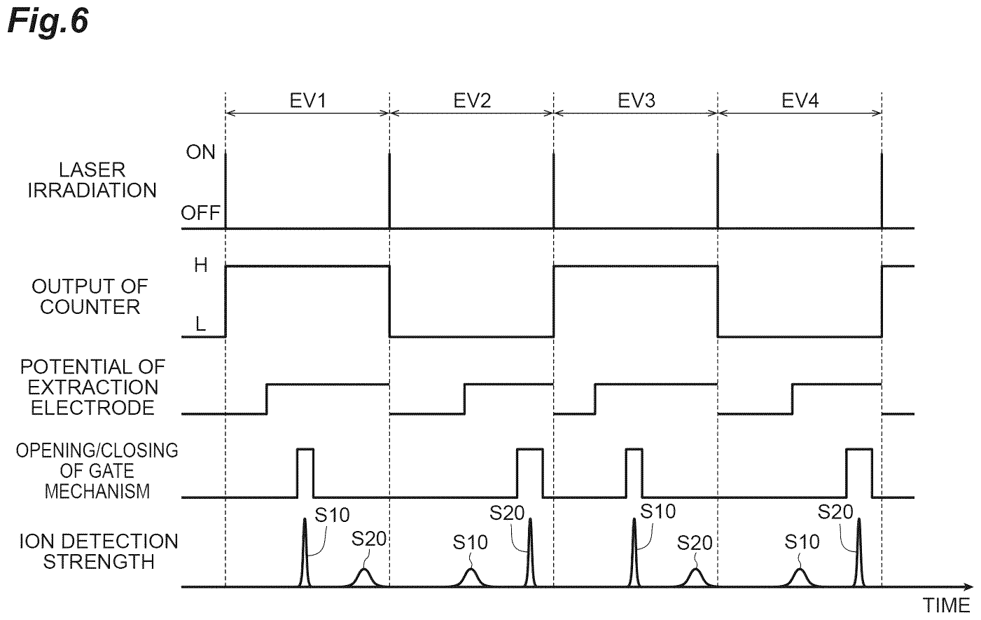

In a case where a unit process corresponding to one irradiation of the energy beam L1 by the irradiation unit 3 is one event, the control unit 5 may execute a plurality of events while changing the detection target component for every event. FIG. 5 is a diagram showing patterns of opening/closing control of the gate mechanism 432 and potential control of the extraction electrode 11 according to such an embodiment. FIG. 6 is a diagram illustrating an operation of a plurality of events according to an embodiment. In the embodiment shown in FIGS. 5 and 6, the mass spectrometer 1 performs mass spectrometry alternately for two types of components S10 and S20 among the components S10, S20, and S30 described above as detection targets.

As shown in FIG. 5, the control unit 5 stores a control pattern of the gate mechanism 432 in advance. The control pattern of the gate mechanism 432 is, for example, a pattern in which a period for setting the gate mechanism 432 to an open state is determined based on a time point at which the energy beam L1 is irradiated on the sample S. In this embodiment, the control unit 5 stores in advance a first gate pattern corresponding to the component S10 and a second gate pattern corresponding to the component S20 as control patterns of the gate mechanism 432. The first gate pattern is a pattern in which the gate mechanism 432 is set to the open state in the period p1 in accordance with the component S10 and the gate mechanism 432 is set to the close state in the period other than the period p1. The second gate pattern is a pattern in which the gate mechanism 432 is set to the open state in the period p2 in accordance with the component S20, and the gate mechanism 432 is set to the close state in the period other than the period p2.

The control unit 5 stores in advance a potential control pattern of the extraction electrode 11. The potential control pattern of the extraction electrode 11 is, for example, a pattern in which timing for increasing the potential of the extraction electrode 11 by a predetermined amount is determined based on a time point at which the energy beam L1 is irradiated on the sample S. In this embodiment, the control unit 5 previously stores a first potential pattern corresponding to the component S10 and a second potential pattern corresponding to the component S20 as the potential control pattern of the extraction electrode 11. The first potential pattern is a pattern which defines that the potential of the extraction electrode 11 is increased by a predetermined amount in the timing t1 in accordance with the component S10. The second potential pattern is a pattern which defines that the potential of the extraction electrode 11 is increased by a predetermined amount in the timing t2 in accordance with the component S20.

The opening/closing operation of the gate mechanism 432 as described above can be realized by switching between opening and closing based on a voltage signal generated by a function generator (that is, switching between high and low potentials between the photocathode 431b and the CMOS image sensor 431c as illustrated in FIG. 3), for example. In addition, as illustrated in FIG. 6, in this embodiment, the control unit 5 includes a counter configured to switch between a period in which an H (high) signal is output and a period in which an L (low) signal is output by using irradiation of an energy beam L1 as a trigger. The control unit 5 causes the irradiation unit 3 to irradiate the energy beam L1 in a pulsed manner and causes the counter to count the irradiation of the energy beam L1, thereby switching the output from the counter as “H L” or “L H” every time the irradiation of the energy beam L1 is performed. Further, the control unit 5 switches between the first gate pattern and the second gate pattern according to the output from the counter. For example, the control unit 5 operates the gate mechanism 432 in the first gate pattern based on a time point at which the output from the counter is switched to the H signal, and operates the gate mechanism 432 in the second gate pattern based on a time point at which the output from the counter is switched to the L signal. Further, the control unit 5 switches the first potential pattern and the second potential pattern according to the output from the counter. For example, the control unit 5 controls the potential of the extraction electrode 11 in the first potential pattern based on the time point at which the output from the counter is switched to the H signal, and controls the potential of the extraction electrode 11 in the second potential pattern based on the time point at which the output from the counter is switched to the L signal.

FIG. 6 illustrates a case where four events EV1 to EV4 are continuously performed. As shown in FIG. 6, according to the above-described control, in the first and third events EV1 and EV3 in which the counter output is the H signal, the potential of the extraction electrode 11 is raised in the timing t1 in accordance with the component S10, and the gate mechanism 432 is set to the open state in the period p1 in accordance with the component S10. That is, in the events EV1 and EV3, imaging mass spectrometry suitable for the component S10 is realized. More specifically, in the events EV1 and EV3, it is possible to improve the mass resolution of the component S10, and it is possible to reduce the amount of information acquired and stored in one imaging (the amount of data) by acquiring only the data necessary for the analysis of the component S10 (the data corresponding to the period p1). Similarly, in the events EV2 and EV4, imaging mass spectrometry suitable for component S20 is realized. More specifically, in the events EV2 and EV4, it is possible to improve the mass resolution of the component S20, and it is possible to reduce the amount of information acquired and stored in one imaging (the amount of data) by acquiring only the data necessary for the analysis of the component S20 (the data corresponding to the period p2).

The data processing unit 6 performs a process of superimposing a plurality of images captured by the imaging part 43. For example, the data processing unit 6 may generate one image by superimposing images captured in the above-described events EV1 and EV2. Accordingly, it is possible to observe images corresponding to the components S10 and S20 in the one image. That is, the positions of the components S10 and S20 can be confirmed by one image. The imaging part 43 may generate a clear image of the component by superimposing (integrating) a plurality of images captured for the same component. For example, when it is desired to analyze (observe) only the component S10, the data processing unit 6 can obtain a clear image related to the component S10 by superimposing an image captured in the event EV1 and an image captured in the event EV3. Similarly, the data processing unit 6 can obtain a clear image related to the component S20 by superimposing the image captured in the event EV2 and the image captured in the event EV4.

According to the mass spectrometer 1 described above, after the irradiation of the sample S1 with the energy beam L1, the potential of the extraction electrode 11 is changed at the timing in accordance with the detection target component (for example, timing t1, t2, and t3 in accordance with each component S10, S20, and S30 as illustrated in FIG. 4), thereby improving the mass resolution of the detection target component. Further, by acquiring an image as an analysis target in a period in accordance with the detection target component (for example, period p1, p2, and p3 in accordance with each component S10, S20, and S30 as illustrated in FIG. 4), it is possible to reduce the amount of information (data amount) acquired and stored as an analysis target in one imaging. As described above, the processing speed can be improved while improving the mass resolution.

The mass spectrometer 1 includes the ground electrode 12 which is disposed between the extraction electrode 11 and the MCP 41 and accelerates the ionized sample S2 extracted by the extraction electrode 11 by a potential difference between the ground electrode 12 and the extraction electrode 11. In addition, the timing according to the detection target component may be a timing at which the ionized sample S2 corresponding to the detection target component is located between the extraction electrode 11 and the ground electrode 12. According to the above configuration, the mass resolution of the detection target component can be reliably improved.

The mass spectrometer 1 includes the phosphor 42 disposed between the MCP 41 and the imaging part 43, and configured to emit fluorescence L2 (light) corresponding to the electrons E emitted by the MCP 41. Further, the imaging part 43 may acquire an image based on the light from the phosphor 42. According to the above configuration, a sensor or the like that detects light can be used as the imaging part 43.

The fluorescent material of the phosphor 42 may be GaN, ZnO or a plastic scintillator. According to the above configuration, the afterglow time of the fluorescent material can be shortened. Therefore, even when the interval between the timing at which one component (for example, component S10 in FIG. 4) reaches the imaging part 43 and the timing at which the other component (for example, component S20 in FIG. 4) reaches the imaging part 43 is short, the phosphor 42 can emit light corresponding to the other component without being affected by afterglow corresponding to the one component. Accordingly, light corresponding to each component can be emitted with high accuracy, and the accuracy of mass spectrometry can be improved.

The imaging part 43 includes the gate mechanism 432 configured to be switchable between the open state in which an image based on the fluorescence L2 from the phosphor 42 is captured and the close state in which an image based on the fluorescence L2 from the phosphor 42 is not captured. In addition, the control unit 5 may control the operation of the gate mechanism 432 so that the open state is set in a period in accordance with the detection target component (for example, periods p1, p2, and p3 in accordance with the components S10, S20, and S30 as illustrated in FIG. 4) and the close state is set in a period other than the period. In the present embodiment, as described with reference to FIG. 3, the control unit 5 controls the operation of the gate mechanism 432 by switching the magnitude relationship between the potentials of the photocathode 431b and the CMOS image sensor 431c. According to the above-described configuration, by performing the imaging process only in the period in accordance with the detection target component by the opening/closing operation of the gate mechanism 432, it is possible to appropriately suppress the amount of information acquired and stored in one imaging.

The energy beam L1 may be a laser beam, an electron beam, or an ion beam. According to the above configuration, it is possible to select an appropriate type of energy beam as necessary.

When the unit process corresponding to one irradiation of the energy beam L1 by the irradiation unit 3 is one event, the control unit 5 may execute a plurality of events (for example, events EV1 to EV4 illustrated in FIG. 6) while changing the detection target component for every event. According to the above configuration, it is possible to perform imaging mass spectrometry corresponding to each of a plurality of components while suppressing the amount of information in one event. In the example of FIG. 6, the images corresponding to the component S10 are acquired in the first and third events EV1 and EV3, and the images corresponding to the component S20 are acquired in the second and fourth events EV2 and EV4.

[Mass Spectrometry Method]

Next, a mass spectrometry method using the mass spectrometer 1 will be described. First, as shown in FIG. 1, a sample S is placed on the sample stage 2. Subsequently, the irradiation unit 3 irradiates the sample S with an energy beam L1 (first step). Thus, the plurality of components S1 are ionized while maintaining the positional information of the sample S in the irradiation region of the energy beam L1. As a result, an ionized sample S2 which is an ionized component S1 of the sample S is generated.

Subsequently, the ionized sample S2 is extracted from a surface of the sample S by a potential difference between the sample stage 2 and the extraction electrode 11 (second step). Subsequently, as illustrated in FIG. 4, after the irradiation of the energy beam L1 by the irradiation unit 3, the potential of the extraction electrode 11 is changed in a timing t1 in accordance with a predetermined detection target component (here, as an example, a component S10) among one or more components included in the sample S (third step). Here, the control unit 5 increases the potential of the extraction electrode 11 by a predetermined amount when the ionized sample S2 corresponding to the detection target component is a positive ion, and decreases the potential of the extraction electrode 11 by a predetermined amount when the ionized sample S2 corresponding to the detection target component is a negative ion. As a result, it is possible to reduce variation in timing at which the group of the ionized samples S2 related to the detection target component reaches the imaging part 43, and improve the mass resolution of the detection target component.

Subsequently, the MCP 41 disposed downstream of the extraction electrode 11 in the flight path of the ionized sample S2 is caused to emit the electrons E in accordance with the ionized sample S2 (fourth step). Subsequently, the imaging part 43 disposed at the subsequent stage of the MCP 41 is caused to acquire an image based on the electrons E1 emitted by the MCP 41 (in the present embodiment, an image based on the fluorescence L2 converted from the electron E1 by the phosphor 42) (fifth step). Here, the control unit 5 causes the imaging part 43 to acquire an image as an analysis target in a period p1 in accordance with the detection target component (here, as an example, a component S10). In the present embodiment, the control unit 5 causes the imaging part 43 to acquire only an image corresponding to the period p1 by setting the gate mechanism 432 to the open state only in the period p1.

According to the mass spectrometry method using the mass spectrometer 1 described above, the potential of the extraction electrode 11 is changed at a timing in accordance with the detection target component after irradiation of the sample S with the energy beam L1, whereby the mass resolution of the detection target component can be improved. Furthermore, by acquiring an image as an analysis target in a period in accordance with the detection target component, it is possible to reduce the amount of information (data amount) acquired and stored as an analysis target in one imaging. As described above, the processing speed can be improved while improving the mass resolution.

In addition, as described with reference to FIG. 6, when the unit process from the first step to the fifth step is one event, the mass spectrometer 1 may execute a plurality of events EV1 to EV4 while changing the detection target component for each event (in the example of FIG. 6, while alternately changing the detection target component between the components S10 and S20). According to the above configuration, it is possible to perform imaging mass spectrometry corresponding to each of a plurality of components while suppressing the amount of information in one event.

[Modification]

Although one embodiment of the present disclosure has been described above, the present disclosure is not limited to the above embodiment. The material and shape of each component are not limited to those described above, and various materials and shapes may be employed.

In the above-described embodiment, an example in which analysis (event) of two types of components S10 and S20 is alternately repeated is illustrated. However, the control unit 5 may store in advance control patterns (patterns of opening/closing control of the gate mechanism and potential control of the extraction electrode) corresponding to three or more types of components, and may execute a plurality of events by switching the control pattern according to each component for each event.

In addition, in the above-described embodiment related to execution control of a plurality of events, control by an analog circuit using a counter is exemplified, but processing of switching a control pattern (a pattern of opening/closing control of the gate mechanism and potential control of the extraction electrode) for each event may be performed by microcomputer control, PC control, or the like.

Further, the configuration of the imaging unit 4 is not limited to the above-described embodiment. Hereinafter, some modifications of the imaging unit 4 will be described.

(First Modification of Imaging Unit)

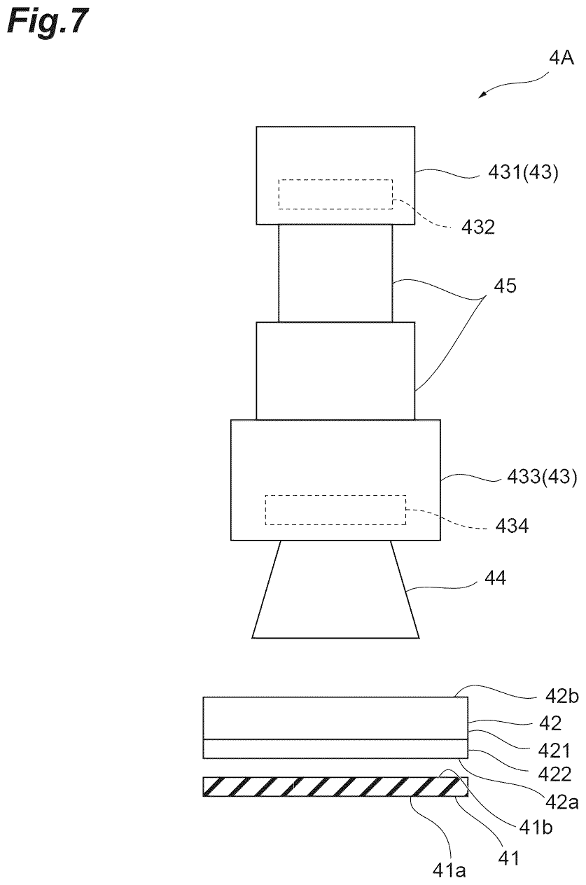

FIG. 7 is a diagram illustrating a first modification example of the imaging unit (imaging unit 4A). The imaging unit 4A is different from the imaging unit 4 in that it further includes an optical relay lens (connecting unit) 45 and an image intensifier 433. In the imaging unit 4A, the imaging part 43 includes a solid state image sensor 431 and the image intensifier 433. The solid state image sensor 431 is disposed at a subsequent stage of the image intensifier 433. That is, the solid state image sensor 431 is disposed on a side opposite to the phosphor 42 with respect to the image intensifier 433. The image intensifier 433 includes a gate mechanism 434. The optical relay lens 45 is disposed between the image intensifier 433 and the solid state image sensor 431. The optical relay lens 45 optically connects the image intensifier 433 and the solid state image sensor 431.

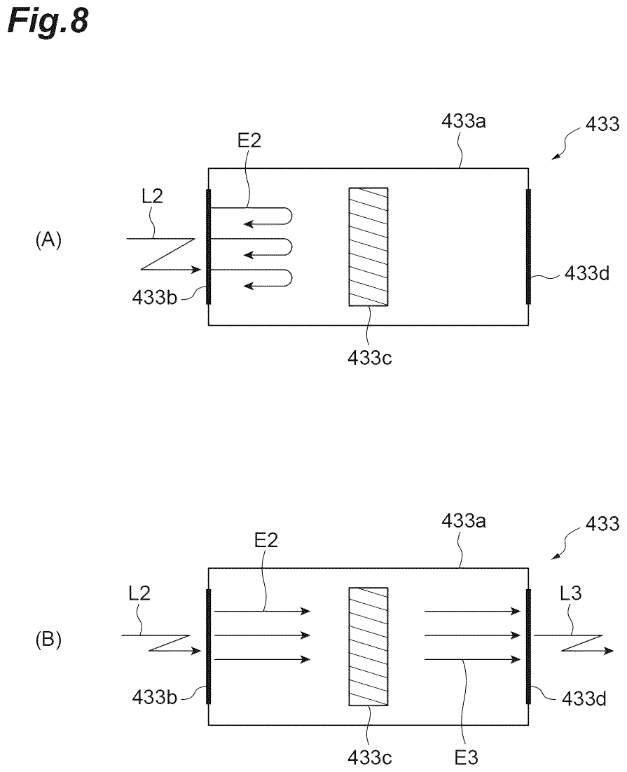

As illustrated in FIG. 8, as an example, the image intensifier 433 includes a housing 433a, a photocathode 433b, an MCP 433c, and a fluorescent surface 433d. The photocathode 433b is provided on an incident surface of the fluorescence L2 in the housing 433a (that is, a surface facing the optical lens 44). The MCP 433c is provided in an evacuated housing 431a at a position facing the photocathode 433b. The fluorescent surface 433d is provided on a surface of the housing 433a opposite to the side where the photocathode 433b is provided (i.e., a surface facing the optical relay lens 45). The photocathode 433b emits electrons E2 (photoelectrons) corresponding to the fluorescence L2 incident on the photocathode 433b to the MCP 433c in the housing 433a. The MCP 433c multiplies the electrons E2. The fluorescent surface 433d converts the electrons E3 multiplied by the MCP 433c into a fluorescence L3, and emits the fluorescence L3 to the solid state image sensor 431 side. The gate mechanism 434 of the image intensifier 433 is implemented by the photocathode 433b and the MCP 433c. More specifically, the switching control of the gate mechanism 434 is realized by controlling the magnitude relationship between the potential of the photocathode 433b and the potential of the MCP 433c.
(A) of FIG. 8 shows the close state. The control unit 5 controls the electrons E2 emitted from the photocathode 433b not to move toward the MCP 433c by making the potential of the photocathode 433b larger than the potential of the MCP 433c. As an example, the control unit 5 sets the potential of the MCP 433c to 0V and sets the potential of the photocathode 433b to 30V. Thus, the close state is realized.
(B) of FIG. 8 shows the open state. The control unit 5 controls the electrons E2 emitted from the photocathode 433b to move toward the MCP 433c by making the potential of the photocathode 433b smaller than the potential of the MCP 433c. As an example, the control unit 5 sets the potential of the MCP 433c to 0V and sets the potential of the photocathode 433b to −200V. Thus, the open state is realized.

In the imaging unit 4A, the opening and closing control as illustrated in FIG. 3 may be performed by the gate mechanism 434 included in the image intensifier 433 instead of the gate mechanism 432 included in the solid state image sensor 431. According to the imaging unit 4A, the fluorescence L2 from the phosphor 42 can be amplified by the image intensifier 433 and imaged by the solid state image sensor 431. Therefore, even when the fluorescence L2 from the phosphor 42 is very weak, the fluorescence L2 can be imaged. In general, the switching speed of the gate mechanism 434 of the image intensifier 433 is higher than that of the mechanical gate mechanism. Therefore, by using the gate mechanism 434 of the image intensifier 433, even when the interval between the timing at which one component (for example, the component S10 illustrated in FIG. 4) reaches the imaging part 43 and the timing at which the other component (for example, the component S20 illustrated in FIG. 4) reaches the imaging part 43 is short, images corresponding to the respective components can be appropriately separated and captured.

(Second Modification of Imaging Unit)

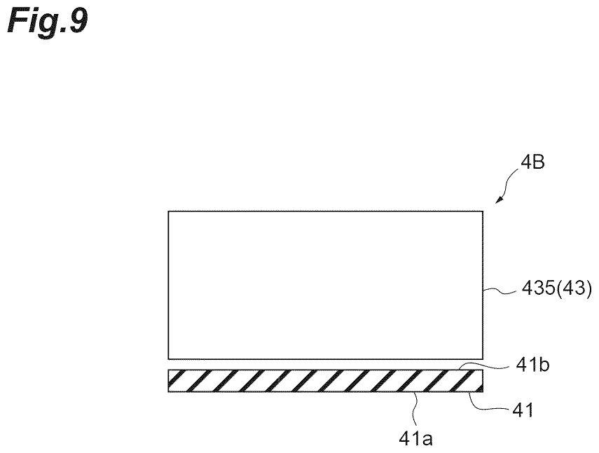

FIG. 9 is a diagram illustrating a second modification example of the imaging unit (imaging unit 4B). The imaging unit 4B is different from the imaging unit 4 in that an electronic sensor 435 as an imaging part 43 is provided instead of the phosphor 42, the optical lens 44, and the solid state image sensor 431. The electronic sensor 435 is a detector having a function of detecting energy of electrons. In the imaging unit 4B, since the electrons E emitted by the MCP 41 can be directly detected by the electronic sensor 435, the phosphor 42 can be omitted. In this case, the control unit 5 may acquire and store, as an analysis target, data related to an image acquired in a period in accordance with the detection target component (for example, periods p1, p2, and p3 in accordance with the components S10, S20, and S30 as illustrated in FIG. 4) among images acquired by the electronic sensor 435. Accordingly, it is possible to reduce the amount of information (data amount) acquired and stored as an analysis target in one imaging.

(Other Modifications of Imaging Unit)

In the imaging unit 4, the solid state image sensor 431 may be a camera (for example, an event-driven camera, a high-speed video camera, or the like) that does not include the gate mechanism 432. In this case, the control unit 5 may acquire and store, as an analysis target, data related to an image acquired in a period in accordance with the detection target component (for example, periods p1, p2, and p3 in accordance with the components S10, S20, and S30 as illustrated in FIG. 4) among images acquired by the solid state image sensor 431. Accordingly, it is possible to reduce the amount of information (data amount) acquired and stored as an analysis target in one imaging.

In the imaging unit 4 and the imaging unit 4A, a fiber optical plate (FOP) may be used instead of the optical lens 44. In this case, the FOP may be directly connected to the output surface 42b of the substrate 421 of the phosphor 42. Similarly, in the imaging unit 4A, the FOP may be used instead of the optical relay lens 45.

Some configurations in one embodiment or modified example described above can be arbitrarily applied to configurations in other embodiments or modified examples.

### REFERENCE SIGNS LIST

1 Mass spectrometer
2 Sample stage
3 Irradiation unit
5 Control unit
11 Extraction electrode (first electrode)
42 Phosphor
43 Imaging unit
431 Solid state image sensor
432, 434 Gate mechanism
433 Image intensifier
E, E1 Electron
EV1, EV2, EV3, EV4 Event
L1 Energy beam
L2, L3 Fluorescence (light)
P1, p2, p3 Period
S Sample
S1, S10, S20, S30 Component
S2 Ionized sample
t1, t2, t3 Timing

1. A mass spectrometer comprising:
a sample stage on which a sample is placed;
an irradiation unit configured to irradiate the sample with an energy beam and ionize a component of the sample while maintaining positional information of the sample in a region irradiated with the energy beam;
a first electrode configured to extract an ionized sample, which is a component of the sample ionized by the irradiation unit, from a surface of the sample by a potential difference between the first electrode and the sample stage;
an electron emission unit disposed downstream of the first electrode in a flight path of the ionized sample and configured to emit electrons in accordance with the ionized sample;
an imaging part disposed at a subsequent stage of the electron emission unit and configured to acquire an image based on the electrons emitted by the electron emission unit; and
a control unit configured to control operations of the irradiation unit, the first electrode, and the imaging part,
wherein the control unit is configured to change a potential of the first electrode at a timing in accordance with a predetermined detection target component among one or more components included in the sample after irradiation of the energy beam by the irradiation unit, and cause the imaging part to acquire the image as an analysis target in a period in accordance with the detection target component, and
at the timing, the control unit is configured to increase the potential of the first electrode by a predetermined amount when the ionized sample corresponding to the detection target component is a positive ion, and decrease the potential of the first electrode by a predetermined amount when the ionized sample corresponding to the detection target component is a negative ion.

2. The mass spectrometer according to claim 1, further comprising a second electrode disposed between the first electrode and the electron emission unit and configured to accelerate the ionized sample extracted by the first electrode by a potential difference from the first electrode, wherein
the timing in accordance with the detection target component is a timing at which the ionized sample corresponding to the detection target component is located between the first electrode and the second electrode.

3. The mass spectrometer according to claim 1, further comprising a phosphor disposed between the electron emission unit and the imaging part and configured to emit light corresponding to the electrons emitted by the electron emission unit, wherein
the imaging part is configured to acquire an image based on the light from the phosphor.

4. The mass spectrometer according to claim 3, wherein
a fluorescent material constituting the phosphor is GaN, ZnO or a plastic scintillator.

5. The mass spectrometer according to claim 3, wherein
the imaging part includes a gate mechanism configured to be switchable between an open state in which an image based on the light from the phosphor is captured and a close state in which an image based on the light from the phosphor is not captured, and
the control unit is configured to control the operation of the gate mechanism so that the open state is set in the period in accordance with the detection target component and the close state is set in a period other than the period.

6. The mass spectrometer according to claim 5, wherein
the imaging part includes:
an image intensifier having the gate mechanism; and
a solid state image sensor disposed at the subsequent stage of the image intensifier.

7. The mass spectrometer according to claim 1, wherein
the energy beam is a laser beam, an electron beam, or an ion beam.

8. The mass spectrometer according to claim 1, wherein
when a unit process corresponding to one irradiation of the energy beam by the irradiation unit is one event, the control unit is configured to execute a plurality of events while changing the detection target component for every event.

9. A mass spectrometry method comprising:
a first step of ionizing a component of a sample while maintaining positional information of the sample in a region irradiated with an energy beam by irradiating the sample with the energy beam by an irradiation unit configured to irradiate the sample with the energy beam;
a second step of extracting an ionized sample, which is a component of the sample ionized by the irradiation unit, from a surface of the sample by a potential difference between a sample stage on which the sample is placed and a first electrode;
a third step of changing a potential of the first electrode at a timing in accordance with a predetermined detection target component among one or more components included in the sample after irradiation of the energy beam by the irradiation unit;
a fourth step of causing an electron emission unit disposed downstream of the first electrode in a flight path of the ionized sample to emit electrons in accordance with the ionized sample; and
a fifth step of causing an imaging part disposed at a subsequent stage of the electron emission unit to acquire an image based on the electrons emitted by the electron emission unit,
wherein, in the third step, when the ionized sample corresponding to the detection target component is a positive ion, the potential of the first electrode is increased by a predetermined amount, and when the ionized sample corresponding to the detection target component is a negative ion, the potential of the first electrode is decreased by a predetermined amount, and
in the fifth step, the imaging part is caused to acquire the image as an analysis target in a period in accordance with the detection target component.

10. The mass spectrometry method according to claim 9, wherein
when a unit process from the first step to the fifth step is one event, a plurality of the events are executed while changing the detection target component for every event.
